(19) United States
(12) Patent Application Publication
(10) Pub. No.: US 2005/0206597 A1
(43) Pub. Date: Sep. 22, 2005

(54) Electro-optical device, method for driving electro-optical device, driving circuit, and electronic apparatus

(75) Inventor: Kenya Ishii, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/048,900

(22) Filed: Feb. 3, 2005

(30) Foreign Application Priority Data
Feb. 10, 2004 (JP) 2004-034057

(51) Int. Cl. G09G 3/36

(52) U.S. Cl. 345/87; 349/5

(57) ABSTRACT

According to exemplary embodiments, three data lines are selected in a horizontal scanning period during which a scanning line is selected. Image signals according to the gradation of pixels corresponding to the intersections of the selected scanning line and the selected data lines are sampled for the selected data lines. While the three data lines are selected, the subsequent three data lines are also selected. Then, image signals according to the gradation of pixels corresponding to the intersections of the selected scanning line and the subsequent three data lines are sampled for the subsequent three data lines. The pixels corresponding to the three data lines selected at the beginning of the horizontal scanning period are included in a non-display area so that they do not contribute to display.

### TECHNICAL FIELD

The present invention relates to a technique for preventing the degradation of display quality when one or more data lines are driven together.

### BACKGROUND ART

A projector for forming small images using an electro-optical panel, such as a liquid-crystal panel, and enlarging and projecting such small images onto a screen, wall, or the like, using an optical system is becoming widespread these days. The projector itself is not capable of creating images, but receives video data (or video signals) from a higher-level apparatus, such as a personal computer or a television tuner. The video data for defining the gradation (brightness) of pixels is fed in the manner of vertical and horizontal scanning of a matrix of pixels. It is thus appropriate that the electro-optical panel used in the projector be driven in such a manner. Therefore, the electro-optical panel used in the projector is generally driven by a dot-sequential method in which, while scanning lines are sequentially selected, data lines are sequentially selected one by one during a period in which one scanning line is selected (one horizontal scanning period), thereby feeding image signals, which are obtained by converting video data to be suitable for driving liquid crystal, to a selected data line.

There are strong demands for higher-definition display these days. Although higher-definition display can be achieved by increasing the number of scanning lines and data lines, an increase in the number of scanning lines leads to a limited length of one horizontal scanning period. Furthermore, in the dot-sequential method, an increase in the number of data lines leads to a limited length of a data-line selection period. In the dot-sequential method, this thus becomes a noticeable problem in that an increase in the level of definition shortens the time for feeding video signals to the data lines, and leads to insufficient writing to pixels.

A method called phase-expansion driving system was devised to solve this problem (see Patent Document 1). In the phase-expansion driving system, during one horizontal scanning period, data lines are simultaneously selected in blocks, each block containing a predetermined number of data lines, for example, six data lines; and at the same time, image signals for pixels corresponding to the intersections of the selected scanning line and selected data lines are expanded by a factor of six along the time axis, and fed to each of the six selected data lines. The phase-expansion driving system is considered suitable for improving definition, because, in this example, the time for feeding image signals to data lines can be increased by six times compared to the case where the dot-sequential method is applied.

[Patent Document 1] Japanese Unexamined Patent Application Publication No. 2000-112437

However, the phase-expansion driving system tends to result in degradation in display quality, due to the simultaneous selection of a plurality of data lines. The degradation is caused by voltage fluctuations in image signals associated with capacitive coupling between blocks of data lines simultaneously selected. The degradation is particularly noticeable, in the form of vertical lines, along data lines.

The present invention has been made in view of the circumstances described above. An object of the present invention is to provide an electro-optical device that can limit the degradation of display quality resulting from phase expansion and can achieve high quality display, a method for driving the electro-optical device, a driving circuit, and an electronic apparatus.

### DISCLOSURE OF INVENTION

To achieve the object described above, an electro-optical device of the present invention includes pixels corresponding to intersections of a plurality of scanning lines and data lines; a scanning-line driving circuit for sequentially selecting the scanning lines; and a data-line driving circuit for sequentially selecting a plurality of blocks, each block including a predetermined number of the data lines, during a horizontal display period in which one of the scanning lines is selected, and simultaneously feeding image signals to the predetermined number of the data lines included in one of the blocks, during a period in which the block is selected. In the electro-optical device, the image signals are fed from the data lines to the pixels. A second block in the plurality of blocks is selected after a first block in the plurality of blocks is selected. A period in which the first block is selected partially overlaps with a period in which the second block is selected. Pixels corresponding to a plurality of data lines selected at the beginning of the horizontal display period do not contribute to display. In this electro-optical device, since one or more data lines are selected while another one or more data lines are selected, selection periods of data lines partially overlap with each other. Moreover, the number of image signal lines is equal to or larger than that of data lines simultaneously selected. This can prevent image degradation, such as ghost images, caused by the feeding of signals from the same image signal line to the data lines simultaneously selected. Capacitive coupling associated with such simultaneous selection affects both data lines in which their respective selection periods overlap with each other. However, since pixels corresponding to one or more data lines initially selected are affected differently from other pixels, they are not allowed to contribute to display, in the present invention, to prevent degradation in display quality.

To make pixels not to contribute to display in the electro-optical device of the present invention, for example, the data-line driving circuit may apply a voltage to one or more data lines selected at the beginning of a period during which one of the scanning lines is selected, for allowing the pixels to have the minimum or close to the minimum brightness. Moreover, for example, a light-shielding layer may be provided for covering the pixels corresponding to one or more data lines selected at the beginning of a period during which one of the scanning lines is selected. Furthermore, all or parts of the pixels may not be provided in one or more data lines selected at the beginning of a period during which one of the scanning lines is selected.

It is preferable that the electro-optical device of the present invention further includes a plurality of image signal lines for feeding image signals. Moreover, it is preferable that the data-line driving circuit includes sampling switches, each switch being electrically connected to one of the data lines at one end and electrically connected to one of the image signal lines at the other end, which are configured such that those corresponding to selected data lines are turned on. This configuration allows for the proper feeding of image signals to data lines in which their respective selection periods partially overlap with each other.

In the configuration for feeding image signals via the image signal lines, it is preferable that the image signals are divided into the image signal lines such that signals for defining the gradation of pixels are expanded along the time axis according to the number of the image signal lines, in synchronization with the selection of data lines in the data-line driving circuit, and fed to the selected data lines. This configuration can increase the time for which image signals are fed to the data lines.

Moreover, if the data-line driving circuit includes the sampling switches, the data-line driving circuit may further include logic circuits, each logic circuit being provided for shaping one pulse such that the one pulse overlaps with a pulse adjacent to the one pulse, and outputting the shaped pulse as a sampling signal for turning on or off one of the sampling switches. Moreover, the logic circuits may be configured such that each logic circuit performs a logic operation between the one pulse and any of a plurality of enable signals that are sequentially phase-shifted. This configuration allows for the overlapping selection of the data lines.

In the electro-optical device of the present invention, the data-line driving circuit may select one or more data lines for only a certain period of time; select another one or more data lines for only a certain period of time while continuously selecting the previously selected data lines; select still another one or more data lines for only a certain period of time while continuously selecting the previously selected data lines; and repeat the operation to select all data lines during a period in which one scanning line is selected. If selected in this manner, all the data lines can be sequentially selected with partial overlapping of selection periods.

The present invention can be conceptualized not only as an electro-optical device, but also as a driving method and a driving circuit. Moreover, degradation in display quality can become less noticeable in the electronic apparatus of the present invention, as the electronic apparatus includes the above-described electro-optical device as a display unit.

### BRIEF DESCRIPTION OF THE DRAWINGS

FIG. 1 is a block diagram showing the structure of an electro-optical device according to an embodiment of the present invention.

FIG. 2 is a block diagram showing the structure of an electro-optical panel in the electro-optical device.

FIG. 3 shows the configuration of pixels in the electro-optical panel.

FIG. 4 is a timing chart showing the operation of the electro-optical device.

FIG. 5 is a timing chart showing the operation of the electro-optical device.

FIG. 6 shows display operation of the electro-optical device.

FIG. 7 shows the structure of a projector to which the electro-optical device is applied.

FIG. 8 is a block diagram showing the structure of an electro-optical panel in an electro-optical device according to a comparative example.

FIG. 9 is a timing chart showing the operation of the electro-optical device of the comparative example.

FIG. 10 shows the display operation of the electro-optical device according to the comparative example.

### REFERENCE NUMERALS

100: electro-optical panel, 102: (display) area, 103a and 103b: (non-display) area, 108: counter electrode, 110: pixel, 112: scanning line, 114: data line, 116: TFT, 118: pixel electrode, 130: scanning-line driving circuit, 140: data-line driving circuit, 141: shift register, 146: sampling switch, 200: control circuit, 300: processing circuit, 2100: projector.

### BEST MODE FOR CARRYING OUT THE INVENTION

Best modes for carrying out the present invention will now be described with reference to the drawings.

### 1. First Embodiment

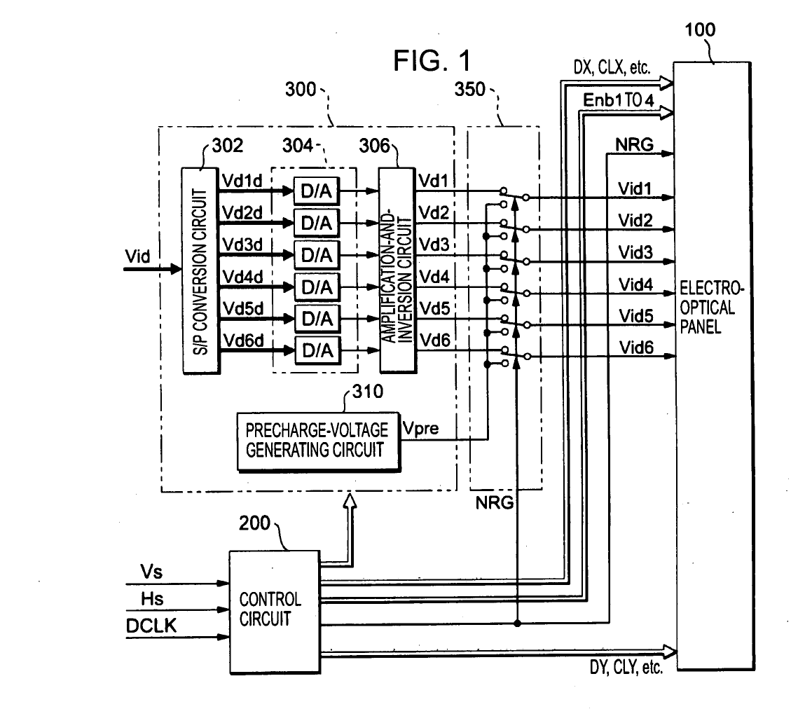

FIG. 1 is a block diagram showing the overall structure of an electro-optical device according to an embodiment of the present invention. As shown in the drawing, the electro-optical device includes an electro-optical panel 100, a control circuit 200, and a processing circuit 300. The control circuit 200 generates timing signals, clock signals, and the like, for controlling each section of the electro-optical device, according to a vertical scanning signal Vs, a horizontal scanning signal Hs, and a dot clock signal DCLK that are supplied from a higher-level apparatus (not shown).

The processing circuit 300 includes an S/P conversion circuit 302, a D/A converter group 304, and an amplification-and-inversion circuit 306.

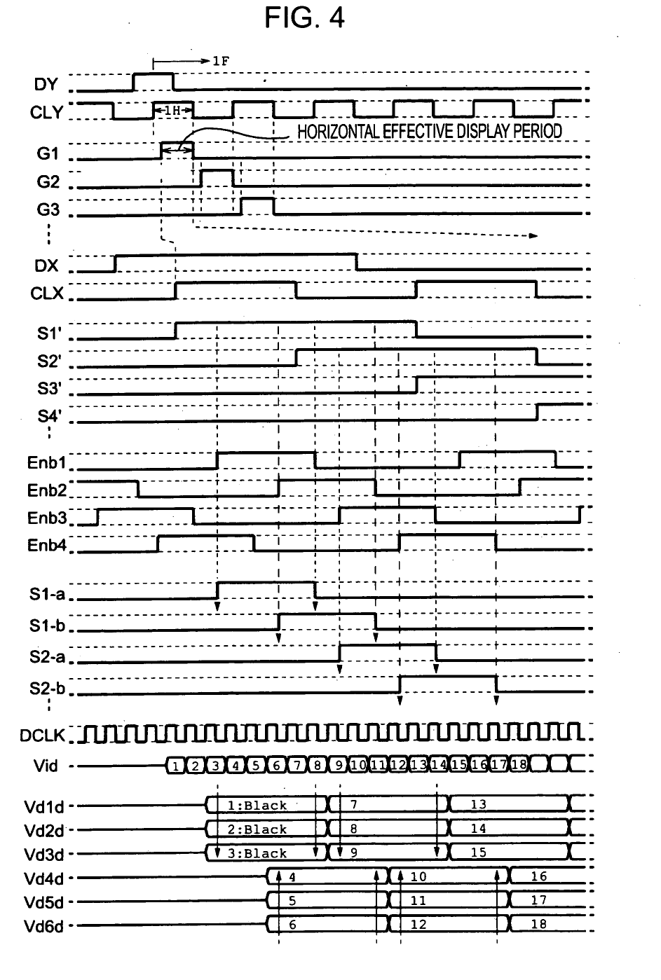

Video data Vid, which designates the gradation (brightness) of each pixel by a digital value, is serially supplied from the higher-level apparatus, in synchronization with the vertical scanning signal Vs, the horizontal scanning signal Hs, and the dot clock signal DCLK. As shown in FIG. 4, the S/P conversion circuit 302 divides the video data Vid into six channels ch1 to ch6, expands them by a factor of six along the time axis (serial to parallel conversion), and outputs them as video data Vd1d to Vd6d.

Therefore, if video data for one pixel is supplied in one cycle of the dot clock DCLK, each of the expanded video data Vd1d to Vd6d will be supplied over six cycles of the dot clock DCLK. When dividing the video data Vid into channels in the present embodiment, the S/P conversion circuit 302 delays the output of channels ch4 to ch6 by three cycles of the dot clock DCLK with respect to channels ch1 to ch3.

The reason for performing serial to parallel conversion is to increase the time for which image signals are applied, thereby securing a sufficient sample and hold time, and charging and discharging time in a sampling switch described below.

The D/A converter group 304 includes D/A converters, each being provided for each of the channels ch1 to ch6. The D/A converter group 304 is for converting each of the video data Vd1d to Vd6d into analog image signals having a voltage corresponding to the gradation of the pixels.

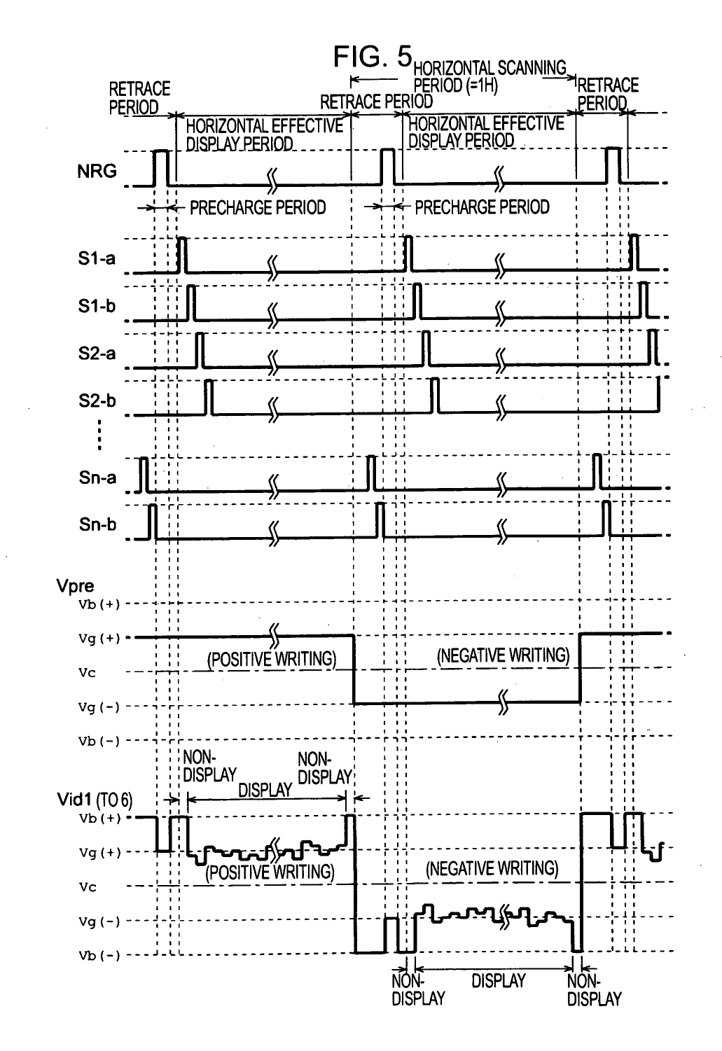

The amplification-and-inversion circuit 306 performs the reverse conversion or normal conversion of the polarity of the converted analog image signals with respect to a voltage Vc, amplifies the image signals as necessary, and supplies them as image signals Vd1 to Vd6. The polarity inversion may be performed, for example, a) on a scanning-line-by-scanning-line basis, b) on a data-signal-line-by-data-signal-line basis, c) on a pixel-by-pixel basis, or d) on a plane (frame)-by-plane basis. For convenience of explanation, the polarity inversion is performed a) on a scanning-line-by-scanning-line basis (1H inversion) in the present embodiment, but there is no intention of limiting the present invention to this. As shown in FIG. 5, the voltage Vc is a voltage at the center of the amplitude of image signals, and is substantially equal to a voltage LCcom applied to a counter electrode. In the present embodiment, for convenience, a voltage higher than the voltage Vc refers to a positive voltage, while a voltage lower than the voltage Vc refers to a negative voltage.

A precharge-voltage generating circuit 310 generates a voltage signal Vpre for precharging, in a retrace period immediately before sampling the image signals for data lines. The voltage of the precharge voltage signal Vpre in the present embodiment is a voltage for turning a pixel to gray (gray-equivalent voltage), which is an intermediate level between white at the highest gradation level and black at the lowest gradation level.

As described above, in the present embodiment, since the polarity inversion is performed on a scanning-line-by-scanning-line basis, positive writing and negative writing are executed alternately in each horizontal scanning period during one vertical scanning period. Therefore, as shown in FIG. 5, the precharge-voltage generating circuit 310 reverses the polarity of the precharge voltage signal Vpre in each horizontal scanning period in a manner such that the voltage becomes a positive gray-equivalent voltage Vg (+) in a retrace period immediately before the positive writing, and becomes a negative gray-equivalent voltage Vg (−) in a retrace period immediately before the negative writing.

Referring back to FIG. 1, a selector 350 selects, for example, the image signals Vd1 to Vd6 from the amplification-and-inversion circuit 306 when a signal NRG is at the L level, while selecting the precharge voltage signal Vpre from the precharge-voltage generating circuit 310 when the signal NRG is at the H level, thereby supplying the selected signals as signals Vid1 to Vid6 to the electro-optical panel 100. Here, the signal NRG is a signal supplied from the control circuit 200 and rises to the H level for some time during a retrace period.

Therefore, the signals Vid1 to Vid6 are the precharge voltage signals Vpre during the period in which the signal NRG is at the H level, and are the image signals Vd1 to Vd6, respectively, during the other periods.

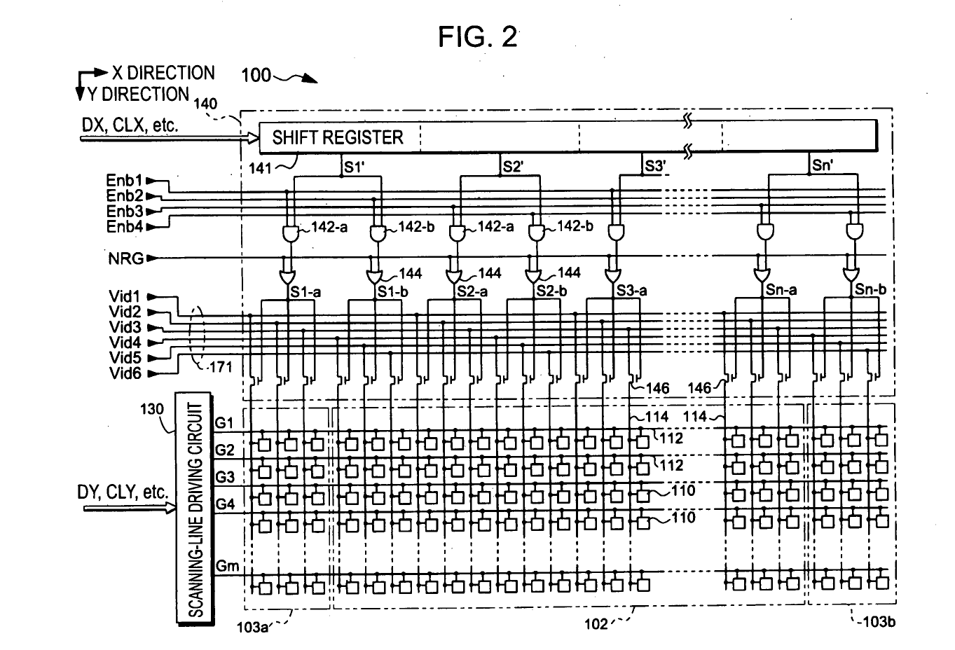

The detailed structure of the electro-optical panel 100 will now be described. FIG. 2 is a block diagram showing the electrical structure of the electro-optical panel 100. The electro-optical panel 100 is a liquid-crystal display panel formed by bonding a device substrate and a counter substrate provided with a counter electrode together, with a certain gap filled with liquid crystal.

In the electro-optical panel 100, as shown in FIG. 2, a plurality of m scanning lines 112 extend in the X direction, while a plurality of 6n (multiples of six) data lines 114 extend in the Y direction. Pixels 110 are provided such that each corresponds to each of the intersections between the scanning lines 112 and the data lines 114. Thus, the pixels 110 are arranged in a matrix with m rows and 6n columns.

In the present embodiment, an area 103a of three columns at the left end and an area 103b of three columns at the right end are used as non-display areas not contributing to the display operation. Therefore, in the present embodiment, a display area 102 contributing to the display operation is an area with m rows and (6n−6) columns obtained by removing an area of three columns at each of the left and right ends.

In the present embodiment, when the data lines 114 included in the non-display areas 103a and 103b are selected, for example, the S/P conversion circuit 302 converts the video data Vid into data at the lowest gradation level corresponding to a black color.

A scanning-line driving circuit 130, a data-line driving circuit 140, and the like are provided around the display area 102 and the non-display areas 103a and 103b. As shown in FIG. 4, the scanning-line driving circuit 130 supplies scanning signals G1, G2, G3, . . . , and Gm, which sequentially rise to and remain at the H level during one horizontal effective display period, to the scanning lines 112 in the first, second, third, . . . , and m-th rows, respectively. The details of the scanning-line driving circuit 130 will not be described here, as they are not directly related to the present invention. The scanning-line driving circuit 130 is configured such that it sequentially shifts a transfer start pulse DY, which is supplied at the beginning of one vertical scanning period (1F), every time the level of a clock signal CLY changes (rises or falls), performs waveform shaping, such as narrowing of the pulse width, and then outputs the scanning signals G1, G2, G3, . . . , and Gm.

The data-line driving circuit 140 includes a shift register 141, AND circuits 142-a, 142-b, and OR circuits 144. The shift register 141 is formed by cascading n stages of latch circuits. A latch circuit in the i-th stage latches an input signal when the level of a clock signal CLX changes, outputs the latched signal as a signal Si′, and supplies it as an input to the subsequent latch circuit in the (i+1)-th stage. An input to a latch circuit in the first stage is a transfer start pulse DX, which is supplied at the beginning of one horizontal scanning period.

Therefore, each of the signals S1′, S2′, s3′, . . . , and Sn′ outputted from a latch circuit in each stage in the shift register 141 is as shown in FIG. 4. That is, the signal S1′ is generated by latching the transfer start pulse DX when the level of the clock signal CLX changes, while the signals S2′, S3′, . . . , and Sn′ are sequentially delayed by a half cycle of the clock signal CLX.

Here, the letter “i” is an integer equal to or greater than 0 and less than or equal to n, and is given to explain the data lines 114, the number of stages of the latch circuits, and the like.

Each of the signals S1′, S2′, S3′, . . . , and Sn′ from the shift register 141 is branched into two paths. Taking the i-th stage as an example, the signal Si′ is branched into two paths and fed to one of the input terminals of each of the AND circuit 142-a and AND circuit 142-b.

If i is an odd number (1, 3, 5, . . . ), an enable signal Enb1 is fed to the other input terminal of the AND circuit 142-a, while an enable signal Enb2 is fed to the other input terminal of the AND circuit 142-b. If i is an even number (2, 4, 6, . . . ), an enable signal Enb3 is fed to the other input terminal of the AND circuit 142-a, while an enable signal Enb4 is fed to the other input terminal of the AND circuit 142-b.

The enable signals Enb1 to Enb4 have substantially the same pulse width in which the signals are at the H level. As shown in FIG. 4, the pulse phases are shifted by 90 degrees with respect to each other, and each pulse width is smaller than the half cycle of the clock signal CLX. The pulse widths in adjacent enable signals partially overlap with each other.

Each OR circuit 144 corresponds to each output of the AND circuits 142-a and 142-b, splits the OR signal of the AND signal from the corresponding AND circuit and the signal NRG into three branches, and supplies them to the gate of each sampling switch 146.

For convenience in explaining the output signal from the OR circuit 144, the OR signal of the AND signal from an AND circuit 142-a and the signal NRG is indicated by sampling signal Si-a, and the OR signal of the AND signal from an AND circuit 142-b and the signal NRG is indicated by sampling signal Si-b.

The sampling switches 146 are, for example, n-channel type thin-film transistors (TFTs) corresponding to the respective data lines 114, and are provided for sampling the six channels of signals Vid1 to Vid6, which are supplied through six image signal lines 171, for the respective data lines 114.

Specifically, when a drain of one of the sampling switches 146 is connected to one end of the data line 114 in the k-th column from the left in FIG. 2, the source is connected to the image signal line 171 to which the signal Vid1 is fed if k divided by six leaves a remainder of 1. Similarly, if a drain of a sampling switch 146 is connected to the data line 114 in the k-th column from the left, where k divided by six leaves a remainder of “2”, “3”, “4”, “5”, or “0”, the source is connected to the image signal line 171 to which the signal Vid2, Vid3, Vid4, Vid5, or Vid6, respectively, is fed.

If drains are connected to the respective data lines 114, where the quotient obtained by dividing k by 6 is i, while the sources are connected to the respective image signal lines 171 to which the sampling signals Vid1 to Vid3 are fed, the same sampling signal Si-a is fed to the respective gates of the sampling switches 146. Similarly, if drains are connected to the respective data lines 114, where the quotient obtained by dividing k by 6 is i, while the sources are connected to the respective image signal lines 171 to which the sampling signals Vid4 to Vid6 are fed, the same sampling signal Si-b is fed to the respective gates of the sampling switches 146.

For example, if a drain of a sampling switch 146 is connected to the data line 114 in the 15th column from the left in FIG. 2, the source of the sampling switch 146 is connected to the image signal line 171 to which the signal Vid3 is fed, because “15” divided by 6 leaves a remainder of “3”. Moreover, since the quotient obtained by dividing “14” by 6 is “2”, a common sampling signal S2-a is fed to the gate of the same sampling switch 146, as well as to the sampling switches 146 corresponding to the data lines 114 in the 13th and 14th columns.

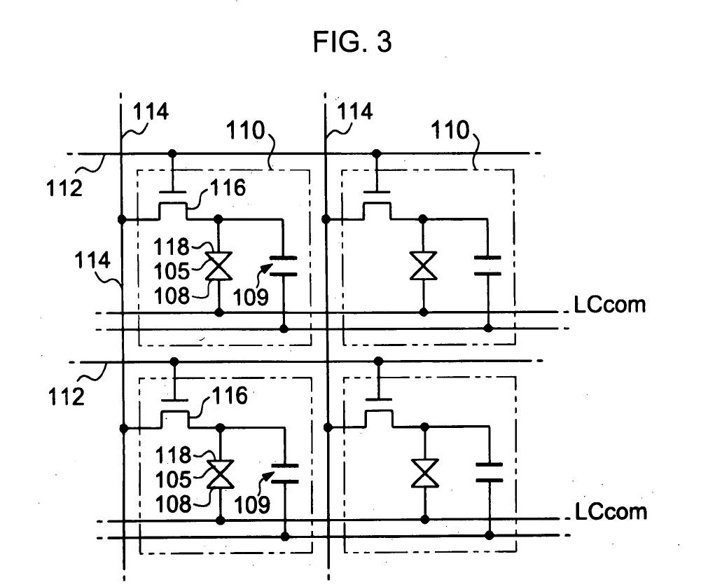

The pixels 110 in the electro-optical panel 100 will now be described. FIG. 3 is a circuit diagram showing the configuration of the pixels 110.

In each pixel, as shown in the drawing, the source of an n-channel type TFT 116 is connected to one of the data lines 114, the drain thereof is connected to a pixel electrode 118, and the gate thereof is connected to one of the scanning lines 112.

A counter electrode 108, which is maintained at the constant voltage LCcom and is common to all the pixels, is disposed opposite the pixel electrodes 118. A liquid-crystal layer 105 is interposed between the pixel electrodes 118 and the counter electrode 108. Liquid-crystal capacitance in each pixel is thus formed by the pixel electrode 118, the counter electrode 108, and the liquid-crystal layer 105.

Although not specifically shown, facing surfaces of two substrates are provided with respective alignment layers, which are subjected to rubbing treatment such that the major axes of liquid-crystal molecules are continuously twisted, for example, by about 90 degrees between the two substrates. The outer surfaces of these substrates are provided with respective polarizers corresponding to the alignment direction.

If a root-mean-square (RMS) voltage of the liquid-crystal capacitance is zero, light passing between the pixel electrodes 118 and the counter electrode 108 is rotated by about 90 degrees along the twist of liquid-crystal molecules. As the RMS voltage increases, the liquid-crystal molecules tilt in the direction of the electric field and lose the rotatory power. For example, when a transmissive panel is in a normally white mode in which polarizers with polarization axes intersecting at right angles, according to the alignment direction, are provided at entry and back sides, if the RMS voltage of the liquid-crystal capacitance is zero, the light transmission reaches its maximum level and white display is provided. On the other hand, as the RMS voltage increases, the amount of light transmission decreases, the light transmission reaches its minimum level, and black display is provided. A storage capacitor 119 is provided in each pixel to prevent leakage of the electric charge in the liquid-crystal capacitance. One end of the storage capacitor 119 is connected to one of the pixel electrodes 118 (drain of a TFT 116), while the other end, which is common to all the pixels, is grounded.

The operation of the electro-optical device of the present embodiment will now be described. FIG. 4 and FIG. 5 are timing charts showing the operation of the electro-optical device.

First, at the beginning of a vertical scanning period, the transfer start pulse DY is fed to the scanning-line driving circuit 130. As shown in FIG. 4, this sequentially enables the scanning signals G1, G2, G3, . . . , and Gm to rise to and remain at the H level during a horizontal effective display period, in a mutually exclusive manner.

The focus will now be on a horizontal effective display period during which the scanning signal G1 is at the H level. In a retrace period immediately before the horizontal effective display period, the signal NRG, as shown in FIG. 5, rises to and remains at the H level during a precharge period, which is isolated from both the beginning and end of the retrace period. It is now assumed that positive writing is performed during this horizontal effective display period. Since the selector 350 (see FIG. 1) selects the precharge voltage signal Vpre when the signal NRG rises to the H level, the six image signal lines 171 (see FIG. 2) are brought to the voltage Vg (+) for positive writing in the subsequent horizontal effective display period.

When the signal NRG rises to the H level, sampling signals, which are AND signals from the OR circuits 144, are forced to the H level, regardless of the output level of the AND circuits 142-a and 142-b, and thus all the sampling switches 146 are turned on. Therefore, when the signal NRG rises to the H level, the precharge voltage signals Vpre of the image signal lines 171 are sampled for all the data lines 114, which are thus precharged at the voltage Vg (+) for the subsequent positive writing.

On completion of the retrace period, the transfer start pulse DX is sequentially shifted by each latch circuit in the shift register 141, and is, as shown in FIG. 4, outputted as the sampling signals S1′, S2′, S3′, . . . , and Sn′ over the respective horizontal effective display periods.

One of the branched signals from the signal S1′ and the enable signal Enb1 are ANDed by an AND circuit 142-a and outputted as the sampling signal S1-a. The other branched signal from the signal S1′ and the enable signal Enb2 are ANDed by an AND circuit 142-b and outputted as the sampling signal S1-b. Since the trailing edge of the pulse of the enable signal Enb1 overlaps with the leading edge of the pulse of the enable signal Enb2, the period during which the sampling signal S1-a is at the H level partially overlaps with the comparable period of the sampling signal S1-b.

Subsequently, one of the branched signals from the signal S2′ and the enable signal Enb3 are ANDed by an AND circuit 142-a and outputted as the sampling signal S2-a. The other branched signal from the signal S2′ and the enable signal Enb4 are ANDed by an AND circuit 142-b and outputted as the sampling signal S2-b.

The leading edge of the pulse of the enable signal Enb3 overlaps with the trailing edge of the enable signal Enb2, while the trailing edge of the pulse of the enable signal Enb3 overlaps with the leading edge of the enable signal Enb4. Therefore, the leading edge of the sampling signal S2-a overlaps with the sampling signal S1-b, while the trailing edge of the sampling signal S2-a overlaps with the sampling signal S2-b.

Similarly, the leading edge of the pulse of the enable signal Enb4 overlaps with the trailing edge of the enable signal Enb3, while the trailing edge of the pulse of the enable signal Enb4 overlaps with the leading edge of the enable signal Enb1. Therefore, the leading edge of the sampling signal S2-a overlaps with the sampling signal S1-b, while the trailing edge of the sampling signal S2-a overlaps with the sampling signal S3-a (not shown in FIG. 4).

In other words, a period during which a sampling signal is at the H level partially overlaps with each comparable period of the respective previous and subsequent sampling signals. In the present embodiment, a maximum of six data lines 114 are simultaneously selected when the sampling signals overlap with each other. Since each of the data lines 114 needs to receive image signals individually from each of the image signal lines 171, six image signal lines 171 according to the maximum number of the data lines 114 are required in the present embodiment.

The video data Vid supplied in synchronization with horizontal scanning is, first, divided by the S/P conversion circuit 302 into six channels and expanded by a factor of six along the time axis, and second, converted by the D/A converter group 304 into analog signals, and, in preparation for positive writing, outputted through normal conversion, with respect to the voltage Vc. Therefore, the voltages of the image signals Vd1 to Vd6 outputted through normal conversion become higher than the voltage Vc as the pixels become black.

Since the signal NRG is at the L level in a horizontal effective display period, the selector 350 selects the image signals Vd1 to Vd6. Therefore, in this case, the signals Vid1 to Vid6 to be fed to the six image signal lines 171 are the image signals Vd1 to Vd6 from the amplification-and-inversion circuit 306.

FIG. 5 shows the change in voltage of the signal Vid1 corresponding to channel ch1, among other signals fed to the six image signal lines 171. In a retrace period, when the voltage of each of the image signals Vd1 to Vd6 is a black-equivalent voltage Vb (+) or Vb (−) depending on the polarity, the voltage of the signal Vid1 fed to an image signal line 171 is one of the black-equivalent voltages. Since the signal Vid1 is the precharge voltage signal Vpre when the signal NRG is at the H level, the voltage of the signal Vid1 is the gray-equivalent voltage Vg (+) or Vg (−) depending on the polarity of the subsequent writing.

In a horizontal effective display period during which the scanning signal G1 is at the H level, when only the sampling signal S1-a rises to the H level, the image signals Vd1 to Vd3 are sampled for the data lines 114 in the first to third columns from the left in FIG. 2, respectively. Then the sampled image signals Vd1 to Vd3 are respectively applied to each pixel electrode 118 in each of the pixels 110 corresponding to the intersections of the scanning line 112 in the first row and the data lines 114 in the first to third columns from the top in FIG. 2.

Since the data lines 114 in the first to third columns are included in the non-display area 103a, image signals to be sampled are at the black-equivalent voltage Vb (+) corresponding to positive writing. Therefore, the pixels from the first row and first column to the first row and third column become black, regardless of the gradation defined by the video data Vid.

When the sampling signal S1-b as well as the sampling signal S1-a rises to the H level, the image signals Vd4 to Vd6, this time, are sampled for the data lines 114 in the fourth to sixth columns, respectively. Then the sampled image signals Vd4 to Vd6 are respectively applied to each pixel electrode 118 in each of the pixels 110 corresponding to the intersections of the scanning line 112 in the first row and the data lines 114 in the fourth to sixth columns. Since the data lines 114 in the fourth to sixth columns are included in the display area 102, the voltage of the sampled image signals are at the gradation level defined by the video data Vid, and corresponds to positive writing. Therefore, the pixels from the first row and fourth column to the first row and sixth column are at a gradation level defined by the video data Vid.

As described above, when the sampling signal S1-b rises to the H level during the period in which only the sampling signal S1-a is at the H level, writing to the pixels 110 corresponding to the intersections of the scanning line 112 in the first row and the data lines 114 in the fourth to sixth columns is executed in parallel with writing to the pixels 110 corresponding to the intersections of the scanning line 112 in the first row and the data lines 114 in the first to third columns.

Then, when the sampling signal S1-a falls to the L level, only the sampling signal S1-b remains at the H level, and the sampling signal S2-a subsequently rises to the H level, the image signals Vd1 to Vd3 are sampled for the data lines 114 in the seventh to ninth columns, respectively. Then the sampled image signals Vd1 to Vd3 are respectively applied to each pixel electrode 118 in each of the pixels 110 corresponding to the intersections of the scanning line 112 in the first row and the data lines 114 in the seventh to ninth columns. Since the data lines 114 in the seventh to ninth columns are also included in the display area 102, the pixels from the first row and seventh column to the first row and ninth column are at a gradation level defined by the video data Vid.

As described above, when the sampling signal S2-a rises to the H level during the period in which only the sampling signal S1-b is at the H level, writing to the pixels 110 corresponding to the intersections of the scanning line 112 in the first row and the data lines 114 in the seventh to ninth columns is executed in parallel with writing to the pixels 110 corresponding to the intersections of the scanning line 112 in the first row and the data lines 114 in the fourth to sixth columns.

Then, when the sampling signal S1-b falls to the L level, only the sampling signal S2-a remains at the H level, and the sampling signal S2-b subsequently rises to the H level, the image signals Vd4 to Vd6 are sampled for the data lines 114 in the tenth to twelfth columns, respectively. Then the sampled image signals Vd4 to Vd6 are respectively applied to each pixel electrode 118 in each of the pixels 110 corresponding to the intersections of the scanning line 112 in the first row and the data lines 114 in the tenth to twelfth columns. Since the data lines 114 in the tenth to twelfth columns are also included in the display area 102, the pixels from the first row and tenth column to the first row and twelfth column are at a gradation level defined by the video data Vid.

Therefore, when the sampling signal S2-b rises to the H level during the period in which only the sampling signal S2-b is at the H level, writing to the pixels 110 corresponding to the intersections of the scanning line 112 in the first row and the data lines 114 in the seventh to ninth columns is executed in parallel with writing to the pixels 110 corresponding to the intersections of the scanning line 112 in the first row and the data lines 114 in the seventh to ninth columns.

Writing to pixels is repeated in the same manner until the sampling signal Sn-b rises to the H level. Writing to all pixels in the first row is thus completed. Since the data lines 114 in the (6n−2)-th to 6n-th columns corresponding to the sampling signal Sn-b are included in the non-display area 103b, image signals to be sampled are at the black-equivalent voltage Vb (+) corresponding to positive writing. Therefore, the pixels from the first row and (6n−2)-th column to the first row and 6n-th column become black, regardless of the gradation defined by the video data Vid.

When the scanning signal G1 falls to the L level, the TFTs 116 connected to the scanning line 112 in the first row are turned off. However, a voltage written during the period in which the TFTs 116 are ON is held in each pixel electrode 118 by each storage capacitor 119 and the capacitance of the liquid-crystal layer. Therefore, a gradation according to the hold voltage is maintained.

Then, in a retrace period immediately before the scanning signal G2 rises to the H level, when a precharge period in which the signal NRG rises to the H level is entered, the precharge voltage signal Vpre from the precharge-voltage generating circuit 310 is fed to each of the six image signal lines 171, as described above. In a horizontal effective display period during which the scanning signal G2 is at the H level, negative writing is performed because of the polarity inversion on a scanning-line-by-scanning-line basis. Therefore, all the data lines 114 are precharged at the voltage Vg (−) for the negative writing.

The other operations are the same as those for the period in which the scanning signal G1 is at the H level. The sampling signals S1-a, S1-b, S2-a, S2-b, . . . , and Sn-b sequentially rise to the H level, thereby completing the writing to all pixels in the second row. For negative writing, the amplification-and-inversion circuit 306 outputs the analog signals from the D/A converter group 304 through reverse conversion, with respect to the voltage Vc. Therefore, the voltages of the signals Vid1 to Vid6 (Vd1 to Vd6) become lower than the voltage Vc as the pixels become black (see FIG. 5).

In the same manner, the scanning signals G3, G4, . . . , and Gm rise to the H level, and writing to pixels in the third, fourth, . . . , and m-th rows is performed. Thus, positive writing is performed on pixels in odd-numbered rows, while negative writing is performed on pixels in even-numbered rows, thereby completing writing to all pixels in the first to m-th rows in one vertical scanning period.

Although writing in the next vertical scanning period (1F) is performed in a similar manner, the polarity of writing to pixels in each row is reversed. That is, in the next vertical scanning period, negative writing is performed on pixels in odd-numbered rows, while positive writing is performed on pixels in even-numbered rows. Since the polarity of writing to pixels is thus reversed in each vertical scanning period, degradation of liquid crystal can be prevented, as no direct current component is applied to the liquid crystal. The polarity of the precharge voltage signal Vpre is also reversed according to the polarity inversion in writing operation.

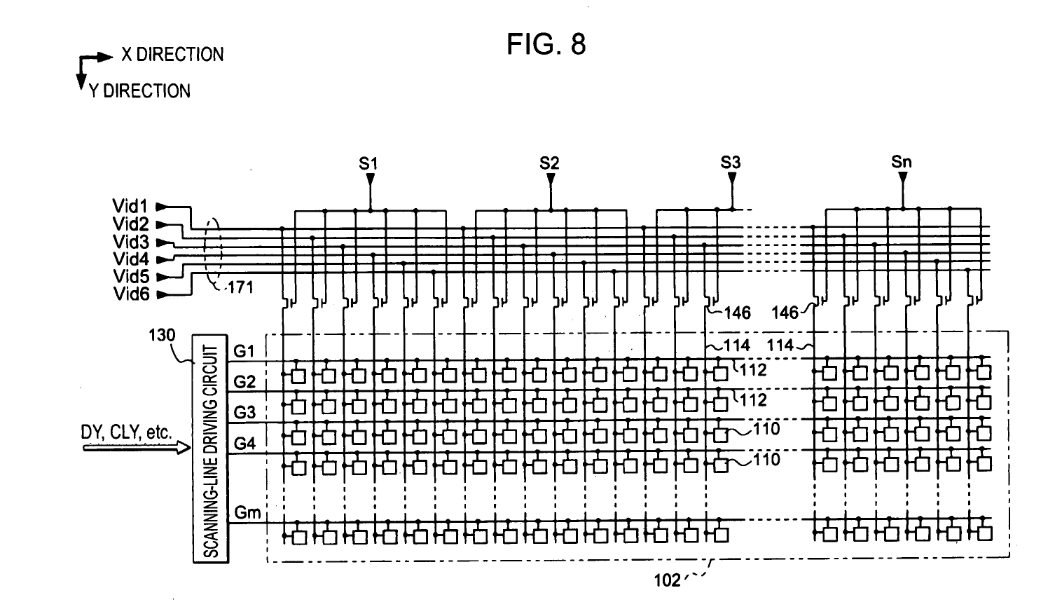

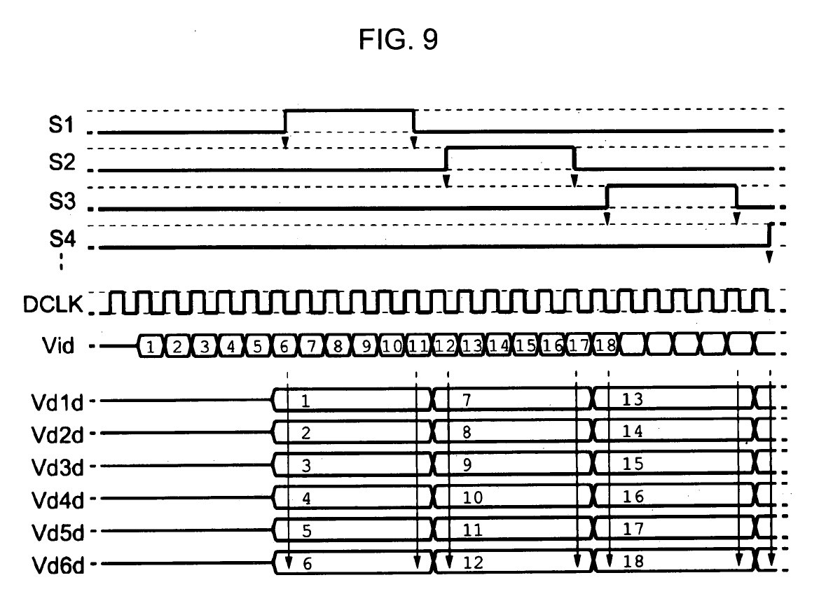

To explain the advantage of the electro-optical device of the present embodiment, a related structure in which six data lines are simultaneously selected will now be described as a comparative example. FIG. 8 is a block diagram showing the structure of a main part of an electro-optical panel, which is in an electro-optical device of the comparative example, in which six data lines are simultaneously selected in one horizontal scanning period. FIG. 9 is a timing chart for explaining the operation of the electro-optical device of the comparative example.

The electro-optical device of the comparative example is different from the electro-optical device of the present embodiment in that, first, six data lines are simultaneously selected, and second, other data lines are not selected during the period in which the six data lines are selected.

The first cause of degradation in display quality, due to simultaneous selection of a plurality of data lines, is that the voltage of the counter electrode 108, which should be constant, fluctuates in response to voltage changes in the image signal lines 171 due to the capacitive coupling between the image signal lines 171 and the counter electrode 108, the capacitive coupling between the data lines 114 and the counter electrode 108, and the resistance of the counter electrode 108.

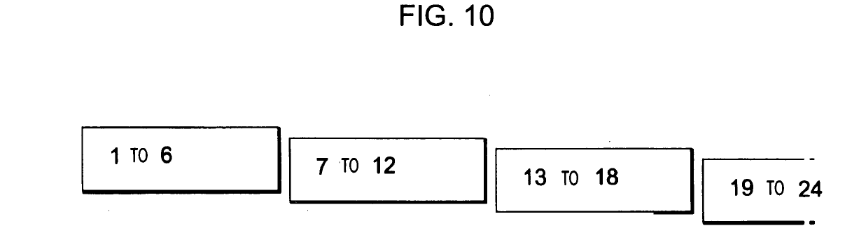

In the above-described comparative example, as shown in FIG. 9 and FIG. 10, the data lines 114 are sequentially selected, in one horizontal scanning period, in the order of the first to sixth columns, seventh to twelfth columns, and thirteenth to eighteenth columns. For example, when the data lines 114 in the first to sixth columns are selected, the voltage of the counter electrode 108 fluctuates due to voltage changes in the image signal lines 171 associated with the feeding of image signals, and due to voltage changes in the data lines 114 associated with the sampling of image signals. If the subsequent data lines 114 in the seventh to twelfth columns are actually selected under the condition where the voltage fluctuations in the counter electrode 108 have not been settled, a voltage held in the liquid crystal capacitance differs from a desired value even if image signals are properly applied to the pixel electrodes 118 in corresponding pixels, because the counter electrode 108 is not at a voltage LCcom. This results in a noticeable degradation in display quality.

In the comparative example, voltage fluctuations in the counter electrode 108 equally affect six data lines simultaneously selected. Therefore, it can be described that a degradation in display quality occurs in each block of six pixels corresponding to the six data lines 114.

In the present embodiment, for example, pixels in the fourth to sixth columns are also affected by voltage fluctuations in the counter electrode 108 associated with the selection of the data lines 114 in the previous first to third columns. Furthermore, pixels in the subsequent seventh to ninth columns are affected by voltage fluctuations associated with the selection of the data lines 114 in the previous fourth to sixth columns. That is, three columns of pixels are affected by voltage fluctuations associated with the selection of three data lines 114 located in the previous stage.

However, in the present embodiment, the influence of voltage fluctuations in the counter electrodes 108 is exerted on each block of three data lines 114. This is fewer than six data lines in the case of the comparative example, and the degradation in display quality becomes less noticeable. Moreover, in the present embodiment, since the video data Vid is expanded by a factor of six along the time axis, similarly to the comparative example, it is less likely to cause an insufficient writing.

Pixels in the first to third columns are not affected by voltage fluctuations in the counter electrode 108, as there is no data line 114 previously selected. In this case, the display quality of pixels in the first to third columns differs from that of pixels in the fourth and subsequent columns, which are affected by voltage fluctuations in the counter electrode 108.

Therefore, as described above, the present embodiment adopts a configuration in which pixels in the first to third columns become black, regardless of the gradation defined by the video data Vid. This configuration can prevent the degradation in display quality, as the pixels in the first to third columns do not contribute to display.

Although pixels in the first to third columns only are included in the non-display area 103a in the present embodiment, there may be some cases where voltage fluctuations are not easily eliminated, depending on the time constant of the counter electrode 108. In such a case, three columns of pixels are affected not only by voltage fluctuations associated with the selection of three data lines 114 located in the previous stage, but also by voltage fluctuations associated with the selection of three data lines 114 located in the previous stage but one. For example, it can be assumed that pixels in the seventh to nine columns are affected not only by voltage fluctuations associated with the selection of the data lines 114 in the fourth to sixth columns, but also by voltage fluctuations associated with the selection of the data lines 114 in the first to third columns. In this case, the pixels in the fourth to sixth columns are not affected by voltage fluctuations in the counter electrodes 108 associated with the selection of the data lines 114 located in the previous stage but one, as there is no data line 114 corresponding to the previous stage but one. Therefore, similarly to the case of the pixels in the first to third columns, the display quality of the pixels in the fourth to sixth columns differs from that of pixels in the fourth and subsequent columns. In this case, the pixels in the fourth to sixth columns can be included in the non-display area 103a.

If degradation in display quality is due to the first reason, it is unnecessary to include pixels in the (6n−2)-th to 6n-th columns on the extreme right in the non-display area 103b.

If the projector is a three-panel type projector corresponding to RGB, a horizontally-flipped image for one color and a normal image for another color need to be produced, combined, and projected, as described below. Therefore, in the data-line driving circuit 140 for producing a horizontally-flipped image in the electro-optical panel, the horizontal scanning direction is from Sn-b to S1-a. In this case, the area 103b needs to become a non-display area, as the data lines 114 in the 6n-th to (6n−2)-th columns are initially selected in one horizontal effective display period.

Unless both the area 103a and the area 103b are non-display areas, bilateral symmetry cannot be maintained in combining images, and a problem arises in that the center of a normal image and the center of a horizontally-flipped image are not aligned on the panels. This is the reason why the area 103b in the present embodiment is a non-display area.

If there is no need to ensure bilateral symmetry, the area 103b may be designed to contribute to display, instead of being a non-display area.

Since the projector may be placed on a table or hung from the ceiling, the scanning-line driving circuit 130 may be configured such that the vertical scanning direction is switchable between the direction from G1 to Gm and the direction from Gm to G1 for producing a vertically-flipped image.

The second cause of degradation in display quality, associated with simultaneous selection of a plurality of data lines, is the capacitive coupling between each of the data lines 114.

In the comparative example described above, first, the data lines 114 in the first to sixth columns are selected, writing to corresponding pixels is completed, and then the subsequent data lines 114 in the seventh to twelfth columns are selected. However, when the data lines 114 in the seventh to twelfth columns are selected, and the sampling of image signals for corresponding pixels causes changes in voltage, the voltage of the data line 114 in the sixth column is changed in response to the voltage change in the adjacent data line in the seventh column. In one horizontal scanning period, all the TFTs 116 corresponding to the selected scanning line are turned on. Therefore, a pixel in the selected row and the sixth column is overwritten with the changed voltage of the data line in the sixth column. This causes the pixel gradation to deviate from a desired value and a noticeable degradation in display quality occurs.

Pixels, such as those in the twelfth or eighteenth column, corresponding to one of the six data lines 114 simultaneously selected, the one line being adjacent to the subsequently selected six data lines 114, tend to be seen as degradation in display quality, due to the same reason as for the pixels corresponding to the data line in the sixth column.

For example, the data lines 114 in the first to fifth columns are also capacitively coupled with the data lines 114 in the seventh (to twelfth) columns, similarly to the data line 114 in the sixth column. However, the impact is negligible compared to the case of the data line 114 in the sixth column, because the data lines 114 in the first to fifth columns are distant from those in the seventh (to twelfth) columns.

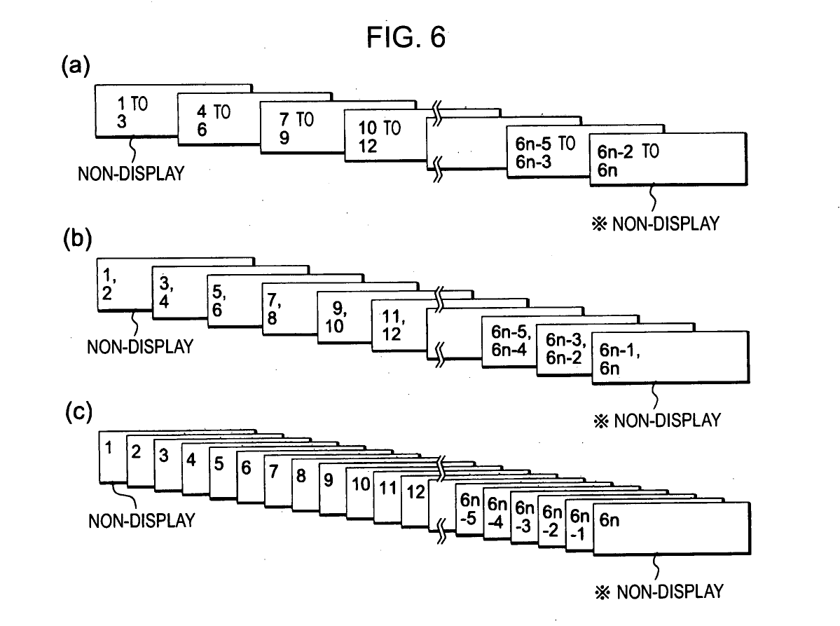

On the other hand, in the present embodiment, as shown in FIG. 6(a), while the data lines 114 in the first to third columns are selected, the subsequent data lines 114 in the fourth to sixth columns are also selected. Furthermore, while the data lines 114 in the fourth to sixth columns are selected, the subsequent data lines 114 in the seventh to ninth columns are also selected. That is, the selection of three data lines 114 overlaps with that of the adjacent three data lines 114 located on both sides.

For example, if the data lines 114 in the fourth to sixth columns are selected while the data lines 114 in the first to third columns are selected, and image signals are sampled for the data line 114 in the fourth column, an electrical connection of the data line 114 in the third column to the corresponding image signal line 171 can be maintained. Therefore, since the data line 114 in the third column is nearly unaffected by voltage changes associated with the sampling of image signals for the data line in the fourth column, a degradation in display quality is less noticeable. The same applies to the sixth, ninth, and other columns.

In the present embodiment described above, pixels in the non-display areas 103a and 103b are forced to black so that they are not allowed to contribute to display. There are other various possible modes of the non-display area, however.

First, for example, pixels in the non-display areas 103a and 103b may be close to black in color.

Second, only the data lines 114 are formed in the non-display areas and all the pixels 110 or parts each pixel 110 may not be provided in the non-display areas. Specific methods to be used include (A) no pixel electrode 118 is formed, (B) no TFT 116 is formed, (C) the pixel electrodes 118 are formed of insulating material, and (D) disconnection or the like is performed to prevent the pixel electrodes 118 or the TFTs 116 from being electrically connected to the data lines 114.

Third, a light-shielding layer (or frame) corresponding to the non-display areas may be provided, regardless of whether or not the pixels 110 are formed.

Moreover, instead of making the pixels in the first to third columns and the (6n−2)-th to 6n-th columns black, black pixels corresponding to the non-display areas may be added to both the left and right sides of the image defined by the video data Vid for image formation.

The non-display areas 103a and 103b may be configured in any manner as long as they can be distinguished from the display area 102.

In the embodiment described above, image signals of channels ch4 to ch6 are delayed by three cycles of the dot clock DCLK with respect to channels ch1 to ch3. It can also be configured such that, for example, image signals of channels ch3 and ch4 are delayed by two cycles of the dot clock DCLK with respect to channels ch1 and ch2, while image signals of channels ch5 and ch6 are delayed by two cycles of the dot clock DCLK with respect to channels ch3 and ch4 (four cycles of the dot clock DCLK with respect to channels ch1 and ch2). In this case, as shown in FIG. 6(b), the number of the data lines 114 included in each block affected by voltage fluctuations in the counter electrode 108 is reduced to as small as two, and a degradation in display quality can thus become less noticeable.

Furthermore, the configuration can also be made such that image signals of channels ch2, ch3, ch4, ch5, and ch6 are delayed by one, two, three, four, and five cycles, respectively, of the dot clock DCLK with respect to channel ch1. In this case, as shown in FIG. 6(c), the number of the data line 114 included in each block affected by voltage fluctuations in the counter electrode 108 is reduced to as small as one, which is minimum, and degradation in display quality can thus become still less noticeable.

Although the video data Vid is divided into six channels of video data vd1d to vd6d in the embodiment described above, the number of channels is not limited to “6”, but may be any number as long as it is 2 or above. For example, it can be configured such that the number of channels is “3”, “12”, “24”, or “48” to feed 3, 12, 24, or 48 channels of image signals.

To simplify control, circuitry, and the like, it is preferable that the number of channels is a multiple of three, as color image signals are generated from signals related to the three primary colors. However, in the case of a three-panel type projector described below, the number of channels is not required to be a multiple of three, as an image in one primary color is formed on one panel.

Although the processing circuit 300 processes the digital video signal Vid in the embodiment described above, it may also be configured to process analog image signals. Although the processing circuit 300 is configured such that digital-to-analog conversion is performed after S/P conversion, it may also be configured such that digital-to-analog conversion is performed before S/P conversion, provided that analog signals are eventually outputted.

Although the embodiment has been described based on the normally white mode in which white display is performed when the RMS voltage between the counter electrode 108 and the pixel electrodes 118 is low, a normally black mode for performing black display is also applicable.

Besides TN-type liquid crystal used in the embodiment described above, possible types of liquid crystal include bistable liquid crystal with memory effects, such as bistable twisted nematic (BTN) liquid crystal and ferroelectric liquid crystal; polymer dispersion liquid crystal; and guest-host (GH) liquid crystal in which a dye (guest) with different visible-light absorbencies between the long and short axes of molecules is dissolved in liquid crystal (host) with a certain molecular arrangement such that the dye molecules and the liquid crystal molecules are arranged in parallel.

The configuration may be a vertical alignment (homeotropic alignment) in which the liquid crystal molecules are arranged orthogonal to both substrates when no voltage is applied and arranged horizontally with respect to both substrates when a voltage is applied, or may be a parallel (horizontal) alignment (homogeneous alignment) in which the liquid crystal molecules are arranged horizontally with respect to both substrates when no voltage is applied and arranged orthogonal to both substrates when a voltage is applied. Thus, the present invention is applicable to various types of liquid crystal and alignment.

Although a liquid-crystal device has been described so far, the present invention is applicable to any device that is configured such that video data (video signal) is fed through image signal lines subsequent to S/P conversion. Examples of such devices include a device using an electroluminescence (EL) element, an electron-emitting element, an electrophoresis element, a digital mirror device (DMD), an LCOS, or the like; and a plasma display. In the case of a device including an LCOS or DMD in which various elements are provided on a silicon substrate, TFTs 116 in pixels 110 may be replaced with transistors.

### 2. Application

<Electronic Apparatus>

A projector using the above-described electro-optical panel 100 as a light valve will now be described as an example of an electronic apparatus using the above-described electro-optical device of the embodiment.

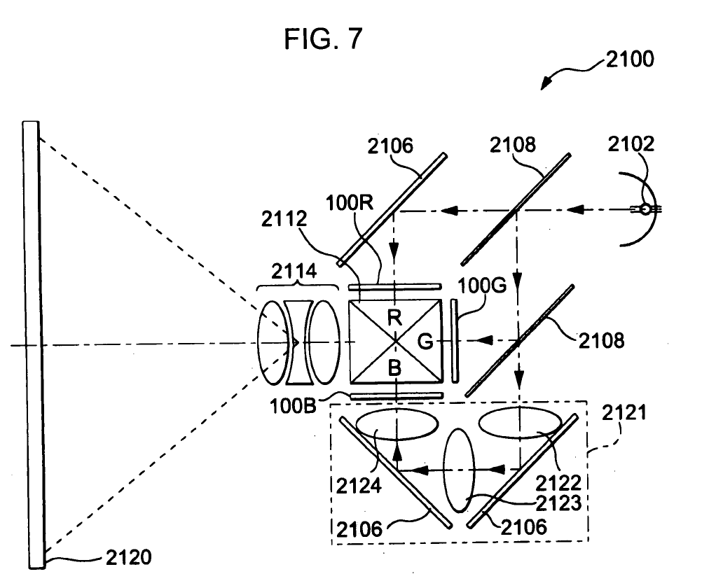

FIG. 7 is a plan view showing the structure of the projector. As shown in the drawing, a projector 2100 includes a lamp unit 2102, which is a white light source, such as a halogen lamp. Light projected from the lamp unit 2102 is divided by internally-arranged three mirrors 2106 and two dichroic mirrors 2108 into three primary colors, red (R), green (G), and blue (B), and guided to light valves 100R, 100G, and 100B corresponding to the respective primary colors. To prevent the loss of the light of color B, which has an optical path longer than that of color R and color G, the light of color B is guided through a relay lens system 2121 including an entrance lens 2122, a relay lens 2123, and an exit lens 2124.

The light valves 100R, 100G, and 100B are configured in the same manner as the electro-optical panel 100 of the embodiment described above, and are driven by image signals, which correspond to the respective colors R, G, and B, supplied from a processing circuit (not shown in FIG. 7).

Light modulated by the light valves 100R, 100G, and 100B enters a dichroic prism 2112 from three directions. The dichroic prism 2112 refracts the light of colors R and B at an angle of 90 degrees, while allowing the light of color G to travel in a straight line. After combining images in respective colors, a color image is projected by a projection lens 2114 onto a screen 2120.

There is no need to provide a color filter, as the dichroic mirrors 2108 allow light corresponding to the primary colors R, G, and B to pass through the light valves 100R, 100G, and 100B, respectively. Although transmitted images from the light valves 100R and 100B are reflected from the dichroic prism 2112 and then projected, a transmitted image from the light valve 100G is directly projected. Therefore, the horizontal scanning direction of the light valves 100R and 100B is reversed with respect to that of the light valve 100G to form a horizontally-flipped image.

Examples of an electronic apparatus, other than that described with reference to FIG. 7, include direct-view apparatuses, such as a cell phone, a personal computer, a television, a monitor for a camcorder, a car navigation system, a pager, an electronic notepad, a calculator, a word processor, a workstation, a videophone, a POS terminal, a digital still camera, and an apparatus with a touch panel. It will be obvious that the electro-optical device of the present invention is applicable to these various electronic apparatuses.

1. An electro-optical device, comprising:
a plurality of scanning lines;
a plurality of data lines;
pixels corresponding to intersections of the plurality of scanning lines and the plurality of data lines;
a scanning-line driving circuit to sequentially select the scanning lines; and
a data-line driving circuit to sequentially select a plurality of blocks, each block including a predetermined number of the data lines, during a horizontal display period in which one of the scanning lines is selected, and to simultaneously feed image signals to the predetermined number of the data lines included in one of the blocks, during a period in which the block is selected,
the image signals being fed from the data lines to the pixels;
the plurality of blocks including a first block and a second block, the second block selected after the first block is selected;
a period in which the first block is selected partially overlapping with a period in which the second block is selected; and
pixels corresponding to a plurality of data lines selected at a beginning of the horizontal display period not contributing to display.

2. The electro-optical device according to claim 1, the data-line driving circuit applying a voltage to one or more data lines selected at the beginning of the horizontal display period, to allow the pixels to have a minimum or close to the minimum brightness.

3. The electro-optical device according to claim 1, further comprising:
a light-shielding layer to cover the pixels corresponding to one or more data lines selected at the beginning of the horizontal display period.

4. The electro-optical device according to claim 1, all or part of the pixels not being provided in one or more data lines selected at the beginning of the horizontal display period.

5. The electro-optical device according to claim 1, further comprising:
a plurality of image signal lines to feed image signals;
the data-line driving circuit comprising sampling switches to sample the image signals from the respective image signal lines for each of the data lines, during the period in which one of the blocks is selected.

6. The electro-optical device according to claim 5, the number of the plurality of image signal lines being larger than the number of the data lines included in one of the blocks.

7. The electro-optical device according to claim 5, the image signals being divided and fed to each of the plurality of image signal lines.

8. The electro-optical device according to claim 5, the data-line driving circuit including circuits, each circuit being provided to shape one pulse such that the one pulse overlaps with a pulse adjacent to the one pulse, and to output the shaped pulse as a sampling signal to control one of the sampling switches.

9. The electro-optical device according to claim 8, one of the circuits outputting the sampling signal based on the one pulse and any of a plurality of enable signals that are sequentially phase-shifted.

10. The electro-optical device according to claim 1, the data-line driving circuit selecting one or more data lines for only a certain period of time;
selecting another one or more data lines for only a certain period of time while continuously selecting the previously selected data lines;
selecting still another one or more data lines for only a certain period of time while continuously selecting the previously selected data lines; and
repeating the operation to select all data lines during a period in which one scanning line is selected.

11. The electro-optical device according to claim 1, pixels corresponding to a plurality of data lines selected at an end of the horizontal display period not contributing to display.

12. A method for driving an electro-optical device including pixels corresponding to intersections of a plurality of scanning lines and a plurality of data lines, the method comprising:
selecting sequentially the scanning lines;
selecting sequentially a plurality of blocks, each block including a predetermined number of the data lines, during a period in which one of the scanning lines is selected;
feeding simultaneously image signals to the predetermined number of the data lines included in one of the blocks, during a period in which the block is selected;
selecting a second block in the plurality of blocks after selecting a first block in the plurality of blocks;
setting a period in which the first block is selected and a period in which the second block is selected such that they partially overlap with each other; and
making pixels, which correspond to one or more data lines selected at a beginning of a period in which one of the scanning lines is selected, to not be displayed.

13. A driving circuit for an electro-optical device including pixels corresponding to intersections of a plurality of scanning lines and a plurality of data lines, the driving circuit, comprising:
a scanning-line selecting circuit to sequentially select the scanning lines; and
a data-line driving circuit,
to sequentially select a plurality of blocks, each block including a predetermined number of the data lines, during a period in which one of the scanning lines is selected;
to simultaneously feed image signals to the predetermined number of the data lines included in one of the blocks, during a period in which the block is selected;
to select a second block in the plurality of blocks after selecting a first block in the plurality of blocks;
to set a period in which the first block is selected and a period in which the second block is selected such that they partially overlap with each other; and
to make pixels, which correspond to one or more data lines selected at the beginning of a period in which one of the scanning lines is selected, to not be displayed.

14. An electronic apparatus, comprising:
the electro-optical device according to claim 1.
